(19) United States
(12) Patent Application Publication
(10) Pub. No.: US 2008/0231966 A1
(43) Pub. Date: Sep. 25, 2008

(54) Variable Lens System

(75) Inventors: Bernardus Hendrikus Wilhelmus Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,537

(22) PCT Filed: Jan. 25, 2005
(86) PCT No.: PCT/IB2005/050289

§ 371 Date: Jul. 28, 2006

(30) Foreign Application Priority Data
Jan. 30, 2004 (EP) 04100351.8
Mar. 9, 2004 (EP) 04100947.3

(51) Int. Cl. G02B 3/14

(52) U.S. Cl. 359/666

(57) ABSTRACT

A compact and substantially achromatic optical lens system (100, 200) comprising an electrowetting lens (104, 204) is provided. The optical lens system is using an electrowetting lens in which at least one of the entrance window surface (117, 217) or exit window surfaces (219), being in contact with one of the fluids (112, 212, 113, 213), has a curvature. When the sign of the curvature of that surface has the same sign as the curvature of the meniscus when no voltage is applied, a low building height is achieved. The optical element (104, 204) not only acts as a focussing or zooming device, but that it also acts as an aberration reduction element for the other elements in the optical lens system (100, 200).

### FIELD OF THE INVENTION

The present invention relates to an optical lens system using a variable lens comprising a first fluid and a second fluid which are in contact over a meniscus, to an imaging system including such an optical lens system and to a method of designing such a variable lens system and optical imaging system.

### BACKGROUND OF THE INVENTITON

A variable lens is a device in which one or more properties of the lens can be controllably adjusted, e.g. in which the focal length or the position of the lens can be altered. An optical lens system is used to image an object on to an image sensor. This optical lens system can comprise a variable lens

The general trend in the development of image sensors for camera modules is that they constantly increase in resolution. Starting from the low-resolution sensors such as the 100k-pixels range CIF image sensors and 300k-pixels image sensors, there are presently high-resolution mega-pixel image sensors available. These higher resolutions not only require a focusing fimction of the optical lens system in order to be able to employ the high resolution over the entire object distance range (e.g. 10 cm to infinity), they also require a lens system containing at least two aspherical lenses to meet other optical performance requirements, such as relating to aberrations. For portable applications, such as a camera in a mobile telephone, the building height of the camera module is important in order that the module fits in the required form factor of the application.

In the international patent application WO2003/069380 a camera module containing an electrowetting lens enclosed by curved lenses as variable lens system is disclosed. An applied voltage controls the shape of the meniscus between both fluids of the electrowetting lens and therefore the optical power of the electrowetting lens. As a result by using such an electrowetting lens in an imaging system, the variable meniscus radius is able to fulfil the focusing requirement and therefore it is possible to remove the defocus of the image. As the meniscus of an electrowetting lens is substantially spherical, it will not significantly contribute to removing optical aberration in the image such as coma, distortion and spherical aberration.

The known electrowetting lens has limited magnification, field flattening and aberration reduction possibilities due to the limited number of optical surfaces. As a result, the module is only suitable for low-resolution cameras such as CIF and VGA. For cameras with for higher resolution sensors such as the 500k-pixel range (S)VGA image sensors, the 1M-pixel range XGA image sensors and mega-pixel devices this is not sufficient.

A ghosting stop as well as an aperture stop are located in front of the first aspherical lens of the prior art camera module. Due to this location straylight entering the lens system can still reflect from the cylindrical wall of the lens system towards the image sensor, resulting in ghosting.

In the US-patent application US2001/017985 a camera lens stack is disclosed containing an electrowetting lens, having flat entrance and exit windows, and containing separate lens groups in front and behind the electrowetting lens. The focusing is performed through movement of the first lens group. The electrowetting lens has a zoom function. A diaphragm is placed in front of the electrowetting lens to control the amount of light towards the image sensor.

The electrowetting lens as described in this US-patent application US2001/017985 only contributes to a zooming action of the camera and not to an improvement of other optical performances. As a result, in such a design the amount of space available for the lens stack is not being used economically, unnecessarily limiting the performance of the module.

In order to achieve a low building height, it is proposed in the same document US2001/017985 to use an electrowetting lens, which has a substantially flat meniscus when no voltage is applied. This flat meniscus reduces the building height.

The above disclosures do only describe single aspects, such as focusing or zooming, of the applied electrowetting lenses, which are not sufficient for compact high-resolution imaging systems as applied in e.g. mobile camera modules.

None of the above disclosures addresses the problem of achromatisation, which is needed to achieve a good optical colour correction of the imaging lens system. For example, a conventional lens system is rendered achromatic by forming a cemented doublet or by combining an ordinary refractive lens and a diffractive lens. For the cemented doublet, normally the two elements forming the lens have substantially the same refractive index and different Abbe-numbers. In order to provide achromatisation, the optical powers K1 and K2 and the Abbe-numbers V1 and V2 of the two elements are chosen such that they comply with the equation:

$$\frac{K 1}{V 1} + \frac{K 2}{V 2} = 0 \qquad ( 1 )$$

Another method to achromatise a refractive lens is by adding a diffractive structure.

Both the above mentioned methods for providing an achromatic lens system are not applicable for electrowetting lenses, because in electrowetting lenses the optical power changes with the radius of the meniscus between the two fluid depending on the applied voltage, while the above mentioned methods apply to fixed optical power lenses only.

It is an object of the invention to provide a variable lens system using a small electrowetting lens, having a low building height and suitable for high resolution imaging systems.

It is furthermore an object of the invention to provide a variable focus lens system having substantially achromatic properties.

### SUMMARY OF THE INVENTION

The object of the invention is achieved by an optical lens system comprising at least a first and a second lens group and a stop, at least one of said lens groups comprising an optical element having a chamber having an entrance window, an exit window and an optical axis extending longitudinally through the chamber, the chamber containing a first fluid and a second fluid in contact over a meniscus extending transverse the optical axis, the fluids being substantially immiscible, and at least one of the entrance window and exit window surfaces, being in contact with a fluid, having a curvature.

Such an optical element, comprising electrodes for applying a voltage such that the shape of the meniscus can be varied in dependence of the applied voltage, is also referred to as an electrowetting lens. The surface of the entrance or exit window being in contact with a fluid can have a curvature with the same sign as the curvature of the meniscus when no voltage is applied. In that case a significant height reduction can be achieved. This method for height reduction is also applicable in optical lens systems in which said optical element is the only element comprising optical power. Also both windows may have curved surfaces.

Independent of using the curved surfaces for building height reduction, the curved surfaces of the windows can also be used for aberration correction of the optical element or even the total optical lens system.

When using curved surfaces for at least one of the entrance or exit window the surfaces of the optical element may take part in the overall optical design. The curvatures of the windows may be used as extra number of degrees of freedom for the optical design to optimise the optical performance of the optical lens system. This means that the curvatures of the windows may be adapted for correction or reduction of aberrations of other elements in the optical lens system. The optimisation may result in a substantial reduction of optical errors such as distortion and spherical aberration. It also allows a reduction in number of optical elements in the total optical system to achieve the required overall optical quality.

The optical element is used in an optical lens system that can comprise more lenses with optical power. It is the object of the invention that the optical element not only acts as a focussing or zooming device, but that it may also act as aberration reduction element for the other elements in the optical lens system.

A special embodiment of the invention provides an optical lens system having an object space and an image space, in which the first lens group comprising the optical element having the chamber is located at the side of the object space, the second lens group located at the side of the image space, and a stop located between the first and second lens group.

The position of the electrowetting lens in the first lens group may result in a small diameter electrowetting lens, resulting also in a low building height and a long focal range. The building height can be further reduced when, in the situation that no voltage is applied, the radius of the curvature of the meniscus is having the same sign as the radius of the curvature of the lens surface in contact with the fluid. A low building height is suitable for e.g. camera application, in mobile telephones.

The stop should preferably be placed close behind or integrated and close to the exit window of the electrowetting lens, when using a small electrowetting lens in the first lens group. This stop can block unwanted reflections in the first lens group, which reflections may otherwise reach the image sensor and result in ghost images.

Instead of an image sensor also other photosensitive elements can be used in the total system for storing the image. An example of such a photosensitive element is a photographic film.

As commonly used image sensors, such as mega-pixel image sensors, have a buried sensitive area, the acceptance angle of the imaging beam is limited to about 20 to 25 degrees. This means that in the design of the optical lens system the maximum chief-ray angle with the optical axis of the optical lens system towards the image sensor is preferably lower than this acceptance angle. A field-flattening lens can be arranged between the electrowetting lens and the image sensor to reduce the chief-ray angles as well as to flatten the focal plane.

To match the dimensions of the image created by the optical image system with the dimensions of the image sensor, a magnifying lens can be arranged between the electrowetting lens and the chief-ray reduction angle lens.

In a further embodiment the Abbe-number of the material of at least one of the windows having a surface with a curvature in contact with a fluid is substantially different from the Abbe-number of the contacting fluid.

Achromatisation is the reduction of the dispersive optical power in an optical system. A dispersive optical power is resulting from the dependence of refractive index n of the materials of the optical elements on the wavelength of the light. The Abbe-number V can express this wavelength dependence:

$$V = \frac{n ( {λ}_{d} ) - 1}{n ( {λ}_{F} ) - n ( {λ}_{C} )} \qquad ( 2 )$$

where n(λᵢ) is the refractive index at wavelength λᵢ, with λ_{d}=587.6 nm, λ_{F}=486.1 nm and λ_{C}=656.3 nm. The dispersion must be well corrected in order to obtain a high optical quality. Conventional lens systems employ grating structures susceptible to haze, or costly doublet components for colour correction. Fluid-based variable lenses make up a lens system that can be made achromatic. For instance, to make the interface between the fluids achromatic the refractive index n and Abbe-number V for the fluids ‘i’ and ‘n’ must obey the relation:

$$\frac{{V}_{i}}{{V}_{j}} = \frac{{n}_{i} - 1}{{n}_{j} - 1} \qquad ( 3 )$$

When the Abbe-numbers of the window material having a curved surface and the fluid contacting this surface are substantially equal, it is not possible to use this interface for achromatisation of the optical element or the total optical lens system. Therefore, having curved surfaces and Abbe-numbers being substantially different from the Abbe-numbers of the fluids being in contact with theses surfaces, it is possible to use these optical properties in the overall design for substantial achromatisation of the optical lens system.

### BRIEF DESCRIPTION OF THE DRAWINGS

FIG. 1 schematically shows an optical lens system according to a first embodiment.

FIG. 2 illustrates the effect of the first embodiment of the invention.

FIG. 3 shows the wavefront aberrations of an optical lens system design according to the first and second embodiment of the invention.

FIG. 4 schematically shows an optical lens system according to the third embodiment of the invention.

FIG. 5 shows the wavefront aberrations of an optical lens system design according to the third embodiment of the invention.

FIG. 6 shows the modulus of the optical transfer function for different wavelengths of an optical lens system design according to the third embodiment.

FIG. 7 illustrates a variable focus image capture device including an optical lens system according to the embodiments of the invention.

### DETAILED DESCRIPTION OF THE PREFERRED EMBODIMENTS

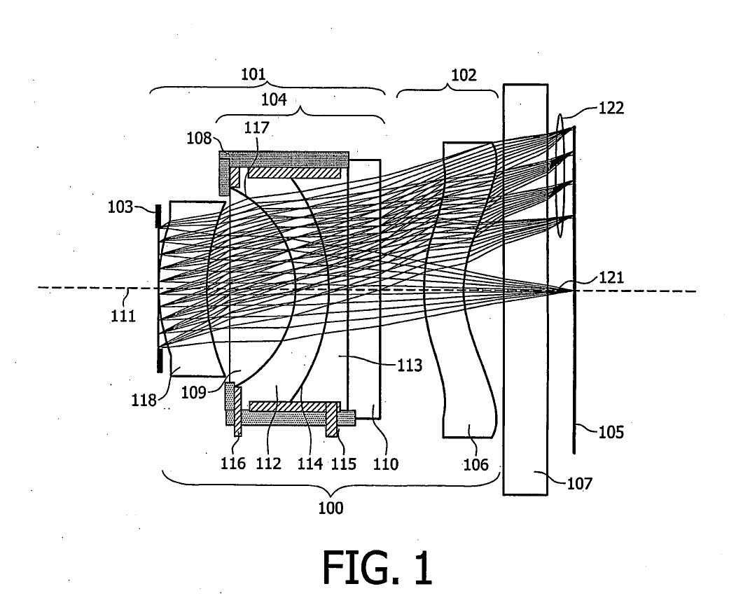

FIG. 1 schematically shows an optical lens system in accordance with a first embodiment of the present invention. The optical lens system (100) comprises two lens groups 101 and 102 and a stop 103 located in front of the first lens group. The first lens group 101 comprises an electrowetting lens 104 as variable lens and acts as a variable focus lens. In the example shown in FIG. 1 the first lens group also determines the magnification of the optical lens system to match the size of the images to the size of the image sensor 105 located behind the optical lens system. The second lens group 102 comprises a field-flattening lens 106 that flattens the focal plane for light rays 122 entering from a field angle in the object space. The image sensor 105 is covered with a transparent cover 107, here a plan parallel plate.

The electrowetting lens includes a chamber 108 having an entrance window 109 and an exit window 110, and an optical axis 111 extending longitudinally through the chamber. The chamber contains a first fluid 112 and a second fluid 113 in contact over a meniscus 114 extending transverse the optical axis. The windows as well as other lenses in the optical lens system may be made of glass, plastic or other suitable material. The chamber may have any shape, e.g. cylindrical, conical, or a shape varying over the length of the chamber.

The stop 103 is reducing the amount of rays of light and straylight that can result in ghosting images at the image sensor 105.

The two fluids 112 and 113 used are being substantially immiscible. The first fluid 112 is an electrically conducting fluid, such as water containing a salt solution, and the second fluid 113 is an electrically insulating fluid, such as silicone oil or an alkane referred to herein further as oil. The two fluids preferably have an equal density, so that the lens operates independently of its orientation, i.e. without dependency on gravitational effects on the fluids.

A first electrode 115 in the chamber is typically a cylinder with a radius between 1 and 20 mm, but can have a different radius or shape depending on the shape and geometry of the chamber. A second, usually annular electrode 116 is arranged at an end of the chamber, in this case near the entrance window. This second electrode 116 is in direct contact with the first fluid 112.

When no voltage is applied to the electrodes 115 and 116, the fluids are in contact over a meniscus 114 having a curvature. The meniscus can be changed to have a smaller or larger radius of curvature by applying a voltage over the electrodes. Further, dependent on the configuration of the chamber and the arrangement of the electrodes a plurality of different shapes of the meniscus can be realized.

Generally, depending on the choice of the oil used, the refractive index of the oil may vary between 1.25 and 1.60. Likewise, depending on the type and amount of salt added, the salt solution may have a refractive index varying between 1.32 and 1.50. The fluids in this embodiment are selected such that the first fluid has a lower refractive index than the second fluid.

In order to reduce the building height, the surface 117 of the entrance window being in contact with the first fluid preferably has a curvature that is the same sign as the curvature of the meniscus 114 in the situation that no voltage is applied over the electrodes 115 and 116.

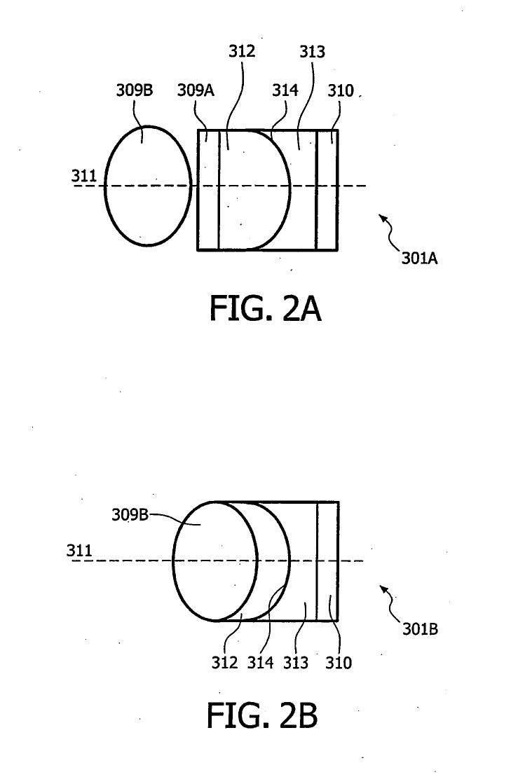

FIG. 2A shows a schematic drawing of an electrowetting lens 301A. The lens comprises two fluids 312 and 313 in contact over a meniscus 314, two flat windows (309A and 310) and a lens 309B arranged externally on an optical axis 311. The curvature of the meniscus 214 has the same sign as the curvature of the surface of lens 309B facing the electrowetting lens.

When the lens 309B is integrated in the electrowetting lens 301A, it also functions as a window and an electrowetting lens 301B as schematically in FIG. 2B is obtained. The figure shows that the electrowetting lens 301B has smaller dimensions along the optical axis 311 than that of the combination as shown in FIG. 2A.

In order to improve the optical performance of the total optical lens system, the surface 117 in FIG. 1 can also have aberration correcting properties. For example, it can have a curvature including an aspherical shape to correct aspherical aberrations introduced by a substantially spherical meniscus of the electrowetting lens. The shape of the surface 117 can also be used to optimise the overall aberration level of the total optical lens system 100.

In a second embodiment of the invention, the electrowetting lens can be made substantially achromatic by a proper choice of the materials of the contacting fluid 112 and the entrance window 109 in combination with an optimised surface curvature for the fluid-window interface 109. This choice of materials may be done on parameters such as refractive index and Abbe-number.

In order to be able to have sufficient freedom in choosing the appropriate lens materials and fluids it is required to allow of a wide range of refractive indices. This can result for example in a substantial difference in refractive index of the material used for the window and the contacting fluid. Allowing such a substantial difference in refractive indices also requires a substantial difference in Abbe-numbers for the window and fluid to optimise for a substantially achromatised electrowetting lens. The choice of materials for window, fluid and curvature also may be optimised for substantially achromatising the total optical lens system.

An example of a design according to the above embodiments and as shown in FIG. 1 is a F/2.5, f=3.47 mm auto focus camera lens with 60 degrees field of view, an entrance pupil of 1.4 mm and a building height of 5.2 mm to be used in combination with a VGA type image sensor having a 5 micron square pixel size. The design of this example consists of the plastic aspherical lens 118 facing the object. The stop 103 is positioned at the object space of this plastic aspherical lens. The plastic aspherical lens is followed by the electrowetting lens 104 sealed with the entrance window 109 made of a truncated glass sphere (e.g. LAK8 by Schott with n=1.53 and V=53.8), followed as first fluid 112 by salted water (n=1.37 and V=38.0) and then as second fluid 113 oil (n=1.53 and V=29.0). Finally the cell is closed with a flat glass plate made of e.g. B270 glass material as exit window 110. The electrowetting lens is followed by another plastic lens, a field-flattening lens 106. The cover 107 of the sensor should also be taken into account with respect to optical properties. In this example a glass plate with n=1.52 and V=64.2 is used.

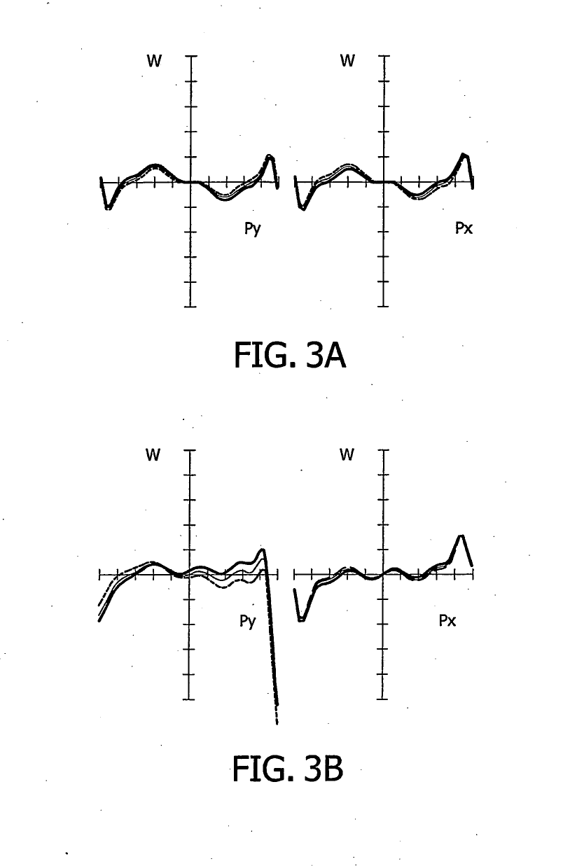

FIG. 3 shows the wavefront aberrations of the optical lens system according to the above design and first embodiment Wavefront aberrations W in micrometers versus the normalized entrance pupil coordinate Px respectively Py are plotted for three wavelengths 490 nm, 560 nm and 625 mn. In FIG. 3a this is shown for a field angle of 0 degrees and in FIG. 3b for a field angle of 30 degrees. The maximum scale in vertical direction of both diagrams is 20 micrometer. These graphs show that the aberrations for the different wavelengths have the same tendency and that the differences of the aberrations between the different wavelengths are sufficiently small to have a substantially achromatised optical lens system.

Although the examples of the first embodiment and second embodiment use an entrance window having a surface with a curvature being in contact with the first fluid, also the surface of the exit window being in contact with the second fluid can have a curvature. Also the choice of the exit window material as well as shape in relation to its optical properties can be optimised such that they contribute to a reduction of aberrations (such as distortion, spherical aberration, chromatic aberration) of the electrowetting lens or total optical lens system.

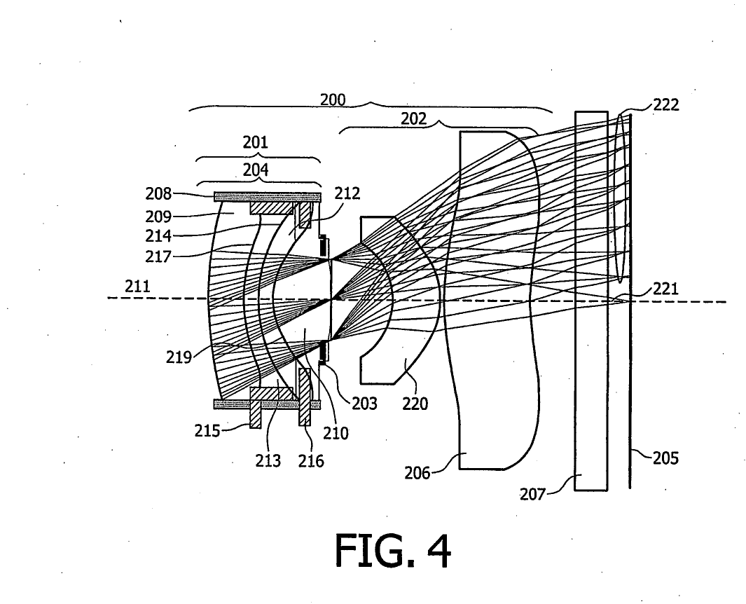

FIG. 4 shows schematically an optical lens system according to a third embodiment of the invention is schematically shown. In this embodiment a combination of choices of fluids and window materials (choices for e.g. refractive index and Abbe-number) with choices of the curvature of both the surfaces of the entrance and exit window is used to substantially reduce the aberrations introduced by the electrowetting lens or even total optical lens system. The optical lens system 200 comprises two lens groups 201 and 202 and a stop 203 located between the first and second lens group. The first lens group 201 comprises an electrowetting lens 204 as variable lens and acts as a variable focus lens. The second lens group 202 determines the optical magnification using a lens 220 to match size of the images with the size of the image sensor 205 located behind the optical lens system. Also it reduces the chief-ray angle by means of a field-flattening lens 206. The image sensor 205 is covered with a transparent cover 207, for example a plane-parallel plate.

The electrowetting lens 204 has a chamber 208 having an entrance window 209 and an exit window 210, and an optical axis 211 extending longitudinally through the chamber. The chamber contains a first fluid 213 and a second fluid 212 in contact over a meniscus 214 extending transverse the optical axis. The radius of the curvature of the surface 217 of the entrance window that is in contact with the first fluid 213 has the same sign as the radius of the curvature of the meniscus 214 between the first and second fluid. Also the radius of the curvature of the surface 219 of the exit window that is in contact with the second fluid 212 has the same sign as the curvature of the meniscus 214 between the first and second fluid. This leads to a reduction of the building height. The windows as well as the lenses can be made of glass, plastic or other suitable material.

The electrowetting lens 204 is located in the first lens group 201 in front of magnifying lens 220 in order to limit the diameter of the electrowetting lens, because after the light rays have passed the magnifying lens 220 the beam diameter is rapidly increasing towards the image sensor. This limitation of diameter of the electrowetting lens also has advantages for cost, focal range, switching speed and building height.

The stop 203 is located before the second lens group in order to reduce ghost images caused for example by unwanted reflections in the electrowetting lens. Preferably the stop is close to or attached to the electrowetting lens near the exit window or even integrated into the electrowetting lens close to the exit window.

An example of a design according to this third embodiment as shown in FIG. 4 is a F/2.8, f=3.97 mm auto focus camera lens with 66 degrees field of view, an entrance pupil of 1.42 mm and a building height of 6.5 mm to be used in combination with a mega-pixel type image sensor. All lenses (209, 210, 220, 206) have aspherical surface in order to optimise the optical quality of the image. The meniscus 214 is substantially spherical. The Abbe-number of the enclosing plastic lenses 209 and 210 of the electrowetting lens 204 is 55.8 and their refractive index is about 1.532 at a wavelength of 560 nm. The conducting fluid 212 comprises salted water and has an Abbe-number of 38 and a refractive index of 1.376 at 560 nm wavelength, while the Abbe-number of the second non-conducting fluid 213, which comprises a silicone oil, is 28 with a refractive index of 1.552 at 560 nm wavelength. By proper choice of the radii of the lenses the optical system can be made substantially achromatic.

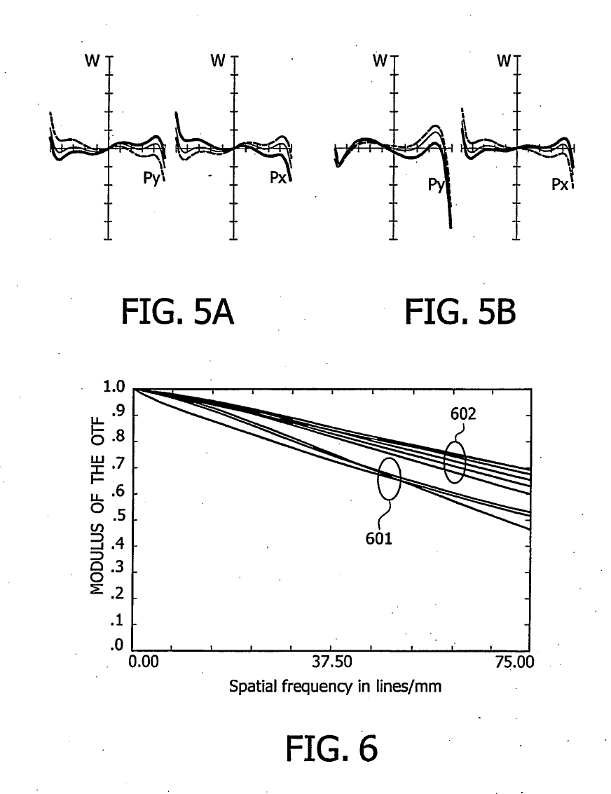

FIG. 5 shows the wavefront aberrations of the optical lens system according to the above design and third embodiment Wavefront aberrations W in micrometers versus the normalized entrance pupil coordinate Px respectively Py are plotted for three wavelengths 490 nm, 560 nm and 625 nm. In FIG. 5a this is shown for a field angle of 0 degrees and in FIG. 5b for a field angle of about 33 degrees. The maximum scale in vertical direction of both diagrams is 50 micrometer. These graphs show that the aberrations for the different wavelengths have the same tendency and that the differences of the aberrations between the different wavelengths are sufficiently small to have a substantially achromatised optical lens system.

FIG. 6 shows the calculated modulus of the polychromatic optical transfer function of the optical lens system according to the above design, averaged over three relevant wavelengths 490 nm, 560 nm and 625 nm, as a function of the amount of lines per millimetre a number of field angles up to about 33 degrees for both the Px direction and the Py direction. It shows two groups of lines 601 and 602. The group of line 601 are the polychromatic optical transfer functions in the Py direction for angles of 20, 29 and 33 degrees. The group of lines 602 are the polychromatic optical transfer functions in the Px direction for angles of 0, 10, 20, 29 and 33 degrees, as well as in the Py direction for angles of 0 and 10 degrees. It shows that up to 75 lines/mm the modulation is sufficient for a mega-pixel imaging application as used in for example a camera in a mobile telephone.

In the example according to a third embodiment all surfaces of both the entrance and exit windows have surface curvatures with radii unequal to zero in order to reduce aberrations such as distortion and spherical aberration, and building height. Depending on the overall system requirements it may also be possible that only a single surface from entrance or exit window has a curvature to reach sufficiently low aberration levels and sufficiently low chromatic aberrations.

The embodiments and examples described in relation to FIGS. 1 and 4 have the electrowetting lens 104 arranged in the first lens group 101; however, the electrowetting lens can also be located in the second lens group 102.

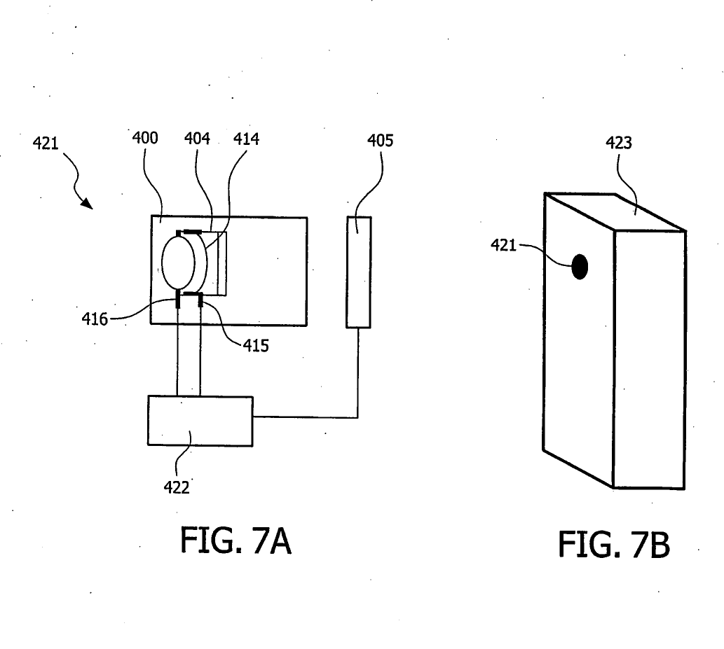

FIG. 7A illustrates a variable focus image capture device 421 including an optical lens system 400 according to the embodiments of the invention. A measuring signal, such as a focussing signal, may be derived from the image sensor 405 using techniques as commonly used in cameras using image sensors. The measuring signal is used as input signal for a voltage driver 422. The output of the voltage driver is connected to the electrodes 415 and 416 of the electrowetting lens 404 in the optical lens system 400 for controlling the shape of the meniscus 414. FIG. 7B shows an example of an application with the variable focus image capture device 421 integrated in an example of a mobile telephone 423. Other integration positions are also possible.

The optical element is very suitable for use in optical lens systems and optical imaging systems for camera applications. These camera applications can be for example movie or still picture hand-held cameras or mobile telephone cameras for movie or still picture. Especially for mobile telephone with camera applications there is an increasing need for devices that are small size, have high optical quality, have a low energy use and are robust. Absence of mechanically moving parts, for e.g. focusing or zooming, makes the optical element according to the invention robust. Optical lens systems and imaging systems that use the optical element according to the invention can fulfil those needs.

Although the above embodiments relate to an optical lens system suitable for small mobile camera systems such as for mobile telephones, the invention can also be used to reduce building height and reduce aberrations of other optical systems, for example in microscopy and optical recording applications.

The optical element according to the invention can be used for example a small size active spherical aberration correction element in optical storage applications. The optical element can be placed between the light source and the objective lens in that application. In combination with the objective lens, a change of optical power of the optical element can introduce spherical aberration in the light-beam that passed to objective lens. This introduce spherical aberration can be used for compensation of the spherical aberration that arises in the optical system due to thickness variations of the substrate or when reading or recording multiple layers in a multi-layer storage medium.

The above descriptions on the variable lens element use the electrowetting principle for altering the shape of the meniscus. Of course, other methods to change the shape of the meniscus between both fluids are considered to fall within the scope of the invention, for example, by means of a pump in combination with a conically shaped electrode arranged to alter controllably the shape and the position of the meniscus.

1. An optical lens system (100, 200) comprising a first lens group (101, 201), a second lens group (102, 202) and a stop (103, 203), at least one of said lens groups comprising an optical element (104, 204) having
a chamber (108, 208) having an entrance window (109, 209), an exit window (110, 210) and an optical axis (111, 211) extending longitudinally through the chamber,
the chamber comprising a first fluid (112, 212) and a second fluid (113, 213) in contact over a meniscus (114, 214) extending transverse the optical axis, the fluids being substantially immiscible,
at least one of the entrance window or exit window comprising a surface (117, 217, 219) being in contact with one of the first or the second fluid, said surface having a curvature.

2. An optical lens system according to claim 1, the chamber (108, 208) further comprising electrodes (115, 116, 215, 216, 415, 416) for applying a voltage for varying the shape of the meniscus in dependence of the applied voltage, the curvature of the surface (117, 217) of the entrance window in contact with one of the first or the second fluid, having the same sign of the curvature as the meniscus when no voltage is applied.

3. An optical lens system according to claim 1, the chamber further comprising electrodes (115, 116, 215, 216, 415, 416) for applying a voltage such that the shape of the meniscus can be varied in dependence on the applied voltage, with the curvature of the surface (219) of the exit window being in contact with one of the first or the second fluid, having the same sign of the curvature as the meniscus when no voltage is applied.

4. An optical lens system according to claim 1, 2 or 3 where at least one of said windows having a surface with a curvature in contact with a fluid is made of a material having an Abbe-number substantially different from the Abbe-number of the contacting fluid.

5. An optical lens system according to any of the preceding claims having an object space and an image space, in which
the first lens group is located at the side of the object space, said first lens group comprising said chamber,
the second lens group is located at the side of the image space,
and the stop is located between the first and second lens group.

6. An optical lens system according to claim 5 where the stop is attached to the first lens group at the side of the image space.

7. An optical lens system according to claims 1, 2, 3 or 4 having an object space and an image space, in which
the first lens group is located at the side of the object space, said first lens group comprising said chamber,
the second lens group is located at the side of the image space,
and the stop is integrated into the first lens group.

8. An optical device comprising an optical lens system according to any of the preceding claims.

9. A mobile telephone comprising an optical lens system according to any of the preceding claims.
